(19) United States
(12) Patent Application Publication
(10) Pub. No.: US 2009/0013092 A1
(43) Pub. Date: Jan. 8, 2009

(54) Method for virtual COM port modbus gateway ethernet I/O

(75) Inventors: Yi-Ming Pao, Hsichih City (TW); Yu-Hung Cheng, Yungho City (TW)

Correspondence Address: BACON & THOMAS, PLLC, 625 SLATERS LANE, FOURTH FLOOR, ALEXANDRIA, VA, 22314-1176, US

(73) Assignee: MOXA TECHNOLOGIES CO., LTD., Shing Tien City (TW)

(21) Appl. No.: 12/230,476

(22) Filed: Aug. 29, 2008

Related U.S. Application Data
(63) Continuation of application No. 11/162,003, filed on Aug. 25, 2005.

(51) Int. Cl. G06F 15/173

(52) U.S. Cl. 709/250

(57) ABSTRACT

A virtual COM port for Modbus gateway Ethernet I/O includes a host terminal, and an I/O controller connected to the host terminal through a network. The host terminal and the I/O controller comprise a first virtual COM port and a second virtual COM port respectively. When transmitting or receiving commands or data, the first virtual COM port of the host terminal and the second virtual COM port of the I/O controller convert the commands or data between the Modbus/RTU format and the Modbus/TCP format. Therefore, a user just downloads the first virtual COM port and the second virtual COM port or externally connects the first virtual COM port and the second virtual COM port to the host terminal and the I/O controller. Accordingly, the maintenance can be simple and carried out easily.

This application is a Continuation-In-Part of my patent application Ser. No. 11/162,003, filed on Aug. 25, 2005.

### BACKGROUND OF THE INVENTION

1. Field of the Invention

The present invention relates to a method for virtual COM port for Modbus gateway Ethernet I/O, more particularly, the present invention enables the user to spend less time and reduce cost for developing program and improve system for mutual transmission of the commands or data between the host terminal and the input/output controller through the network.

2. Description of Related Art

The Internet has changed the people's life style, the operation and development of business. Along with the popularly used in Internet service, the industrial network has rapidly developed as well. The greatest benefit for the industrial network is reduction in the wiring cost. When a host terminal has to be connected to a plurality of input/output (I/O) controllers with different COM ports, for example RS485 RS232 and the universal serial bus (USB), for the mutual commands or data transmission through the standard format of the Modbus/RTU, large quantity of wires makes the wiring arrangement and management complicated. The high management cost and space occupation urges the industrial network provider to develop a single wire in order to reduce the cost. The single network wire can connect hundreds or thousands devices in contrast to the conventional parallel transmission method, which requires connections of hundreds of transmission cables. The method can substantially reduce the management cost, the wire arrangement time and the control panel space. Furthermore, the components connecting to the network are construed as objects that can be added or removed by the software. When the components break down, an error signal is sent to the control end through the network. Meanwhile, the control end monitors or inspects the components through the network. Therefore, the industrial network has taken a crucial position.

Generally, the industrial control system comprises a host connected to at least one I/O controller through the network. Thus, the programmer can design programs and commands by the host terminal through the I/O controller to the components connected to the I/O controller for controlling the components or transmitting data. However, the I/O controller can provide an environmental interface as a standard for the communication with the host terminal, and when the programmer develops an application program, the environmental interface can provide commands for designing a program to control the I/O controller so that the I/O controller can execute the commands from the host terminal. However, the common environmental interfaces provided by the I/O controller usually are technical oriented and systematic level, for example, the dynamic link library (DLL) and ActiveX (a new technology, programmed by Microsoft, enable the software to be created in any language to mutually operate in the network). The programmer has to be experienced in the system with a strong program designing background. Thus, the programmer cannot easily use them.

Furthermore, the programmer has to be extra careful for using DLL. The program can only be loaded for execution when needed, and the system resource must be released when it's not operating. Besides, the programmer has to learn every detailed operation method and command procedure for each application program interface (API), thus the negligence from the programmer can easily cause error in writing program and waste the system resource, which it may further render the system unstable when the error is serious.

Although the components of ActiveX does not require the programmer to process dynamic loading and releasing during the execution, however, the primary system installation and component registration are must for further operation. Except for the above difference, the method of the operation of ActiveX and DLL is almost same.

Additionally, some programmers develop extra system means to enable the user to mutually transmit commands or data between the host terminal and the plurality of I/O controllers through the network.

The defects of the conventional connection between the host terminal and the plurality of I/O controllers may be described as follows.

1. When the host terminal is connected to the plurality of I/O controllers, the programmer has to finish writing the program and tests it to complete the program. Thus, the development cost is higher and uneconomical.

2. When the host terminal is connected to the plurality of I/O controllers, it is needed to write the related higher-level program, like DLL and ActiveX. Unfortunately, these programs can be written only if the programmer is experienced and has a strong program writing background. Not only the programmer has to be very knowledgeable in the software technology for writing the program, but also the programmer has to spend some time to learn to operate it. Thus, the labor cost is accordingly higher in learning and operation.

3. The programmer has to write a program to connect the host terminal and the plurality of I/O controllers. However, the risk exists on the work quality and delicacy of the programmer. Any negligence from the programmer during writing the program will loss the system resource, or further render the system unstable when the error is serious.

4. The connection of the host terminal and the plurality of I/O controllers executed through one sever or by resetting another system will incur heavy cost. Besides, the user has to learn to operate the new system, and it is not practical for the user who has no particular background of the higher-level program technology.

Therefore, to enable the user to simply use the environmental interface provided by the I/O controller and design the required stable program is very essential.

### SUMMARY OF THE INVENTION

Accordingly, the present invention proposes to integrate external components on the method for virtual COM port for Modbus gateway Ethernet I/O.

According to an aspect of the present invention, the host terminal can convert the Modbus/RTU format into the Modbus/TCP format through a first virtual COM port for transmitting the commands or data while the host terminal is connected to the plurality of I/O connector. The first virtual COM port further transmits the converted commands or data to the I/O controllers through a network. Then, a second virtual COM port in the I/O controller converts the commands or data from the Modbus/TCP format into the Modbus/RTU format and then transmits the converted commands or data to serial devices for execution through respective serial transmission. The above first and second virtual COM ports can be presented by the software or the firmware, and operated by downloading or externally connecting to the host terminal and the I/O controller. The user need not have higher level knowledge in program design, and the maintenance is accordingly easier and simpler. Thus the time and cost for random program design and system development can be substantially reduced. Accordingly, the possible system instability caused by the new software developed by the user can also be reduced.

Accordingly to another aspect of the present invention, the user only has to download the software with the functions of the first and second virtual COM ports into the host terminal and the plurality of I/O controllers, or to connect the firmware with the functions of the first and second virtual COM ports to the host terminal and the plurality of I/O controllers. Thus, there is no need of another new system for executing the format conversion between the Modbus/RTU format and the Modbus/TCP format, and the user need not spend time to learn a new system.

According to another aspect of the present invention, the host terminal and the connected I/O controllers mostly use the first COM port interface of the Modbus/RTU, and the programmers and the users are familiar with it. When the host terminal is connected to the plurality of I/O controllers, the host terminal can use the commands or data conversion function provided by the first and second virtual COM ports to enable the programmer or the user to use the familiar first COM port interface as the communication interface between the host terminal and the connected I/O controllers. Thus, the time is reduced and the system instability from designing the program by using another first COM port interface may be avoided. Accordingly, the program development time and cost can be substantially reduced.

### BRIEF DESCRIPTION OF THE DRAWING

FIG. 1 is a block diagram of a virtual COM port for Modbus gateway Ethernet I/O according to a preferred embodiment of the present invention.

FIG. 2 is a flow chart of a method for the virtual COM port for Modbus gateway Ethernet I/O according to the present invention, when transmitting the commands or data from the host terminal to the serial device.

FIG. 3 is a flow chart of a method for the virtual COM port for Modbus gateway Ethernet I/O according to the present invention, when transmitting the commands or data from the serial device to the host terminal.

FIG. 4 is a flow chart of a process for developing a user program according to the present invention.

FIG. 5 is a signal transmission architecture of the virtual COM port for Modbus gateway Ethernet I/O according to the present invention.

FIG. 6 is a flow chart of converting Modbus/TCP and Modbus/RTU according to the present invention (I).

FIG. 7 is a flow chart of converting Modbus/TCP and Modbus/RTU according to the present invention (II).

FIG. 8 is a block diagram of a virtual COM port for Modbus gateway Ethernet I/O according to another preferred embodiment of the present invention.

### DETAIL DESCRIPTION OF THE INVENTION

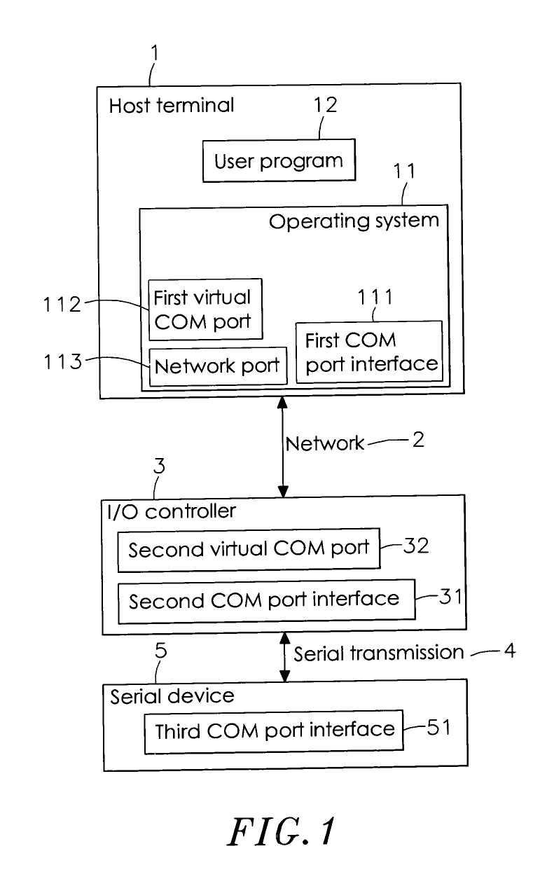

Referring to FIG. 1, the present invention comprises a host terminal 1, a network 2, an I/O controller 3, a serial transmission 4 and a serial device 5.

The host terminal 1 comprises an operating system 11 and a user program 12. The operating system 11 comprises a first COM port interface 111, a first virtual COM port 112 and a network port 113. The first virtual COM port 112 is pre-installed in the host terminal 1 as a non-physical COM port for format conversion between the Modbus/RTU (Remote Terminal Unit) and the Modbus/TCP (Transmission Control Protocol). The presenting modes of the first virtual COM port 112 can be externally install a software or firmware into the host terminal 1. The network port 113 can be wired or wireless. The user program 12 can be a software system or any related programs developed according to a high level SDK (Software Development Kit) and a library backing up the communication of the first COM port interface 111 of the operating system 11, for example, the COM open command, the COM write command and the COM read command. The host terminal 1 can be a personal computer or an industrial computer.

The network 2 is connected to the host terminal 1 to enable the host terminal 1 to transmit or receive commands and data through the network 2. The network 2 can be an Ethernet of the TCP/IP or a wireless LAN.

The I/O controller 3 comprises a second COM port interface 31 and a second virtual COM port 32. The second virtual COM port 32 comprises the same function as the first virtual COM port 112 for format conversion between the Modbus/RTU and the Modbus/TCP. Thus, the I/O controller 3 can receive and transmit commands or data through the network 2. The I/O controller 3 can be an electronic switch, or a digital or analog sensor.

The serial transmission 4 is connected to the I/O controller 3 to enable the I/O controller 3 to transmit or to receive commands and data thereby. The serial transmission 4 can be in RS232, RS42 or RS485 format.

The serial device 5 comprises a third COM port interface 51 connected to the serial transmission 4 for receiving and transmitting commands or data in serial format.

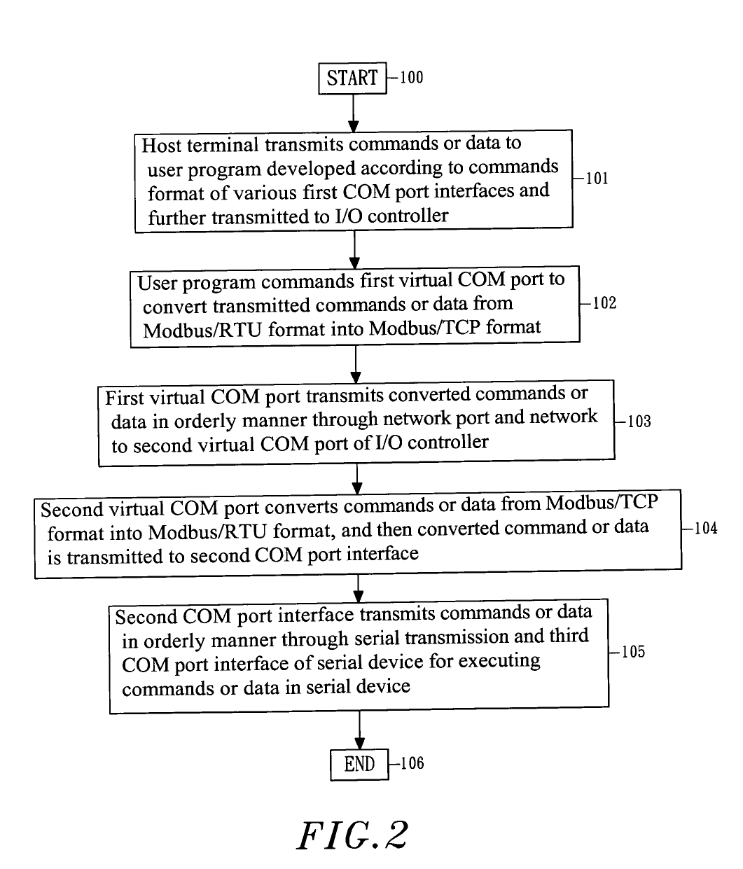

Referring to FIG. 2, the process for transmitting commands or data to the serial device 5 when the host terminal 1 is connected to the I/O connector 3 may be described as follows.

At step 100, the process is started.

At step 101, the host terminal 1 transmits commands or data to the user program 12 developed according to the command format of the first COM port interfaces 111 and further transmitted to the I/O controller 3.

At step 102, the user program 12 commands the first virtual COM port 112 to convert the transmitted commands or data from the Modbus/RTU format into the Modbus/TCP format.

At step 103, the first virtual COM port 112 transmits the converted commands or data in orderly manner through the network port 113 and the network 2 to the second virtual COM port 32 of the I/O controller 3.

At step 104, the second virtual COM port 32 converts the command or data from the Modbus/TCP format into the Modbus/RTU format, and then the converted commands or data is transmitted to the second COM port interface 31.

At step 105, the second COM port interface 31 transmits the command or data in orderly manner through the serial transmission 4 and the third COM port interface 51 of the serial device 5 for executing the commands or data in the serial device 5.

At step 106, the process is ended.

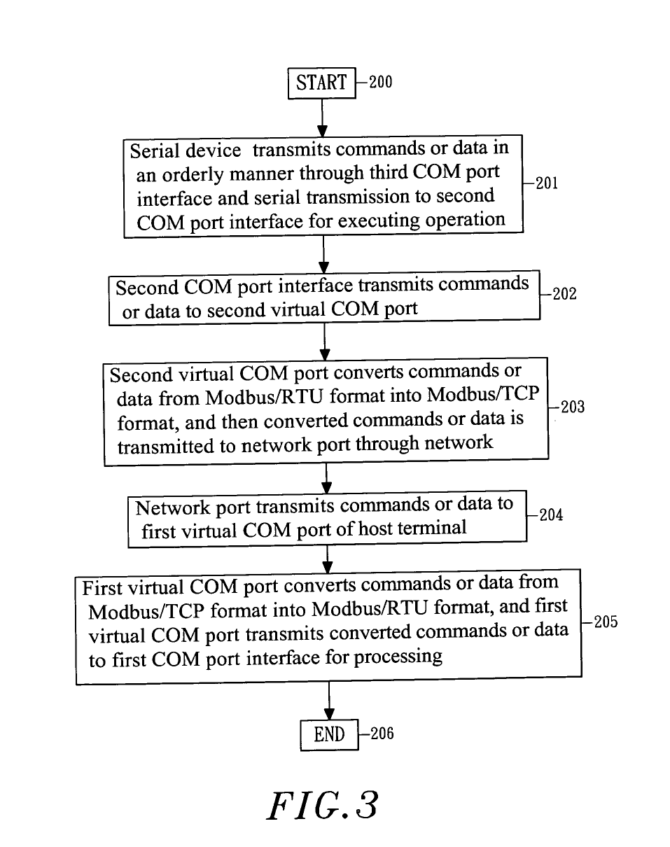

Referring to FIG. 3, the method for transmitting commands or data from the serial device 5 to the host terminal 1 may be described as following.

At step 200, the process is started.

At step 201, the serial device 5 transmits commands or data in an orderly manner through the third COM port interface 51 and the serial transmission 4 to the second COM port interface 31 for executing the operation.

At step 202, the second COM port interface 31 transmits the commands or data to the second virtual COM port 32.

At step 203, the second virtual COM port 32 converts the commands or data from the Modbus/RTU format into the Modbus/TCP format, and then the converted commands or data is transmitted to the network port 113 through the network 2.

At step 204, the network port 113 transmits the command or data to the first virtual COM port 112 of the host terminal 1.

At step 205, the first virtual COM port 112 converts the commands or data from the Modbus/TCP format into the Modbus/RTU format, and the first virtual COM port 112 transmits the converted commands or data to the first COM port interface 111 for processing.

At step 206, the process is ended.

When a user executes the user program 12, the user program 12 sends out the commands or data provided by the first COM port interface 111 in an orderly manner through the first virtual COM port 112, the network port 113 and the network 2 to the second virtual COM port 32 of the I/O controller 3 for conversion. Next, the second COM port interface 31 transmits the commands or data to the serial device 5 via the serial transmission 4 for processing. During the transmission, the first virtual COM port 112 converts the commands or data into the format acceptable by the network 2 upon receiving the commands or data and then transmits it to the second COM port interface 31 for processing through the network 2. Furthermore, if the I/O controller 3 transmits the execution result back to the host terminal 1, the second COM port interface 31 of the I/O controller 3 transmits the commands or data to the second virtual COM port 32 for format conversion, and further transmits to the first virtual COM port 112 of the host terminal 1 through the network 2. At this time, the first virtual COM port 112 converts the received commands or data into the format acceptable by the first COM port interface 111, and then further transmits to the first COM port interface 111 for processing.

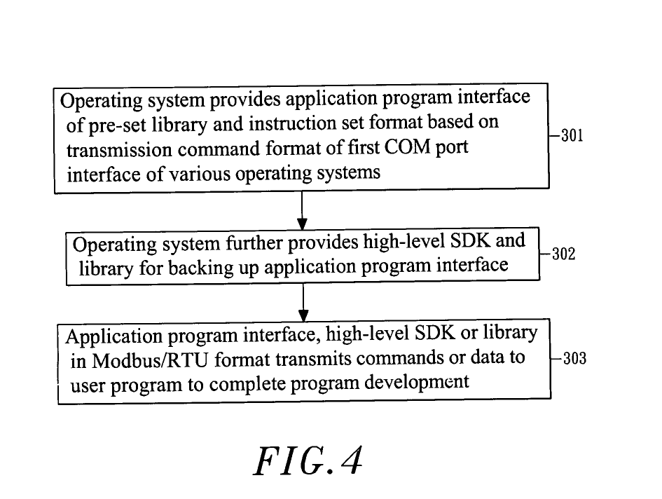

Referring to FIG. 4, the process of developing the user program 12 based on the various first COM port interfaces 111 may be described as following.

At step 301, the operating system 11 provides the application program interface of the pre-set library and the instruction set format based on the transmission command format of the first COM port interface 111 of the various operating systems 11.

At step 302, the operating system 11 further provides the high-level SDK and the library for backing up the application program interface.

At step 303, the application program interface, the high-level SDK or the library in the Modbus/RTU format transmits the command or data to the user program to complete the program development.

According the above description, the command or control method provided by the first COM port interface 111 can be used in designing or modifying the user program 12. Thus, thus the programmer or user need not to learn the commands or control method provided by the second COM port interface 31 of the I/O controller 3. Accordingly, the failures from the I/O controller 3 and the components connected to the I/O controller 3 due to the programmer or user is not being familiar with the second COM port 31 during designing or using the user program 12 can be effectively reduced.

The operating system 11 can be Windows, Linux or other operating system, and the first COM port interface 111 in the Linux operating system is titled TTY interface. In spite of different titles for the first COM port interface 111 in various operating systems 11, the commands, the control method and the function are all identical. Therefore, the first COM port interface 111 and the TTY interface are both included within the scope of the present invention.

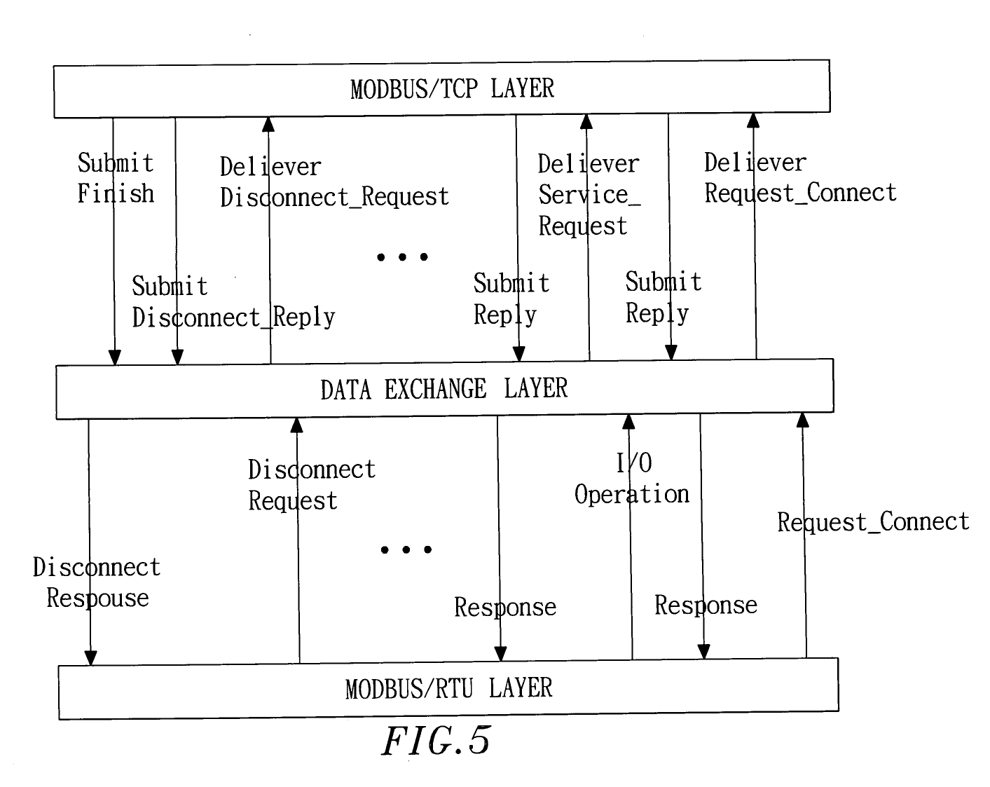

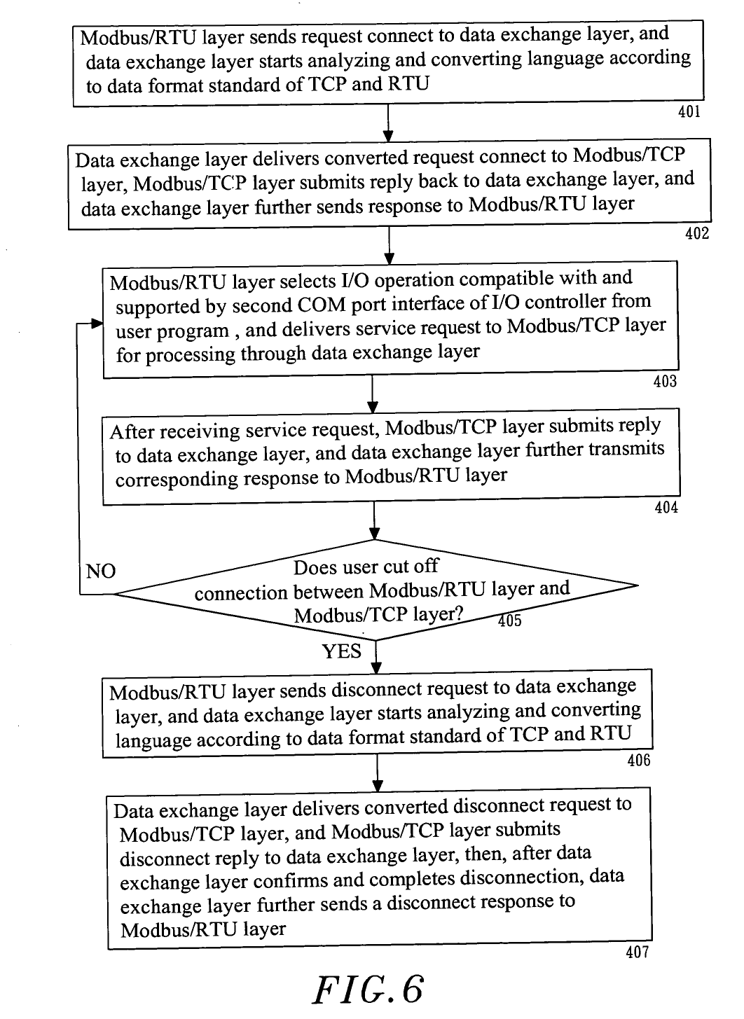

Referring to FIGS. 5 and 6, the conversion process from the Modbus/RTU format to the Modbus/TCP format in the first virtual COM port 112 and the second virtual COM port 32 is described as following.

At step 401, a Modbus/RTU layer sends a request connect to a data exchange layer, and the data exchange layer starts analyzing and converting the language according to the data format standard of TCP and RTU.

At step 402, the data exchange layer delivers the converted request connect to a Modbus/TCP layer, the Modbus/TCP layer submits a reply back to the data exchange layer, and the data exchange layer further sends a response to the Modbus/RTU layer.

At step 403, the Modbus/RTU layer selects an I/O operation compatible with and supported by the second COM port interface 31 of the I/O controller 3 from the user program 12, and delivers a service request to the Modbus/TCP layer for processing through the data exchange layer.

At step 404, after receiving the service request, the Modbus/TCP layer submits a reply to the data exchange layer, and the data exchange layer further transmits a corresponding response to the Modbus/RTU layer.

At step 405, whether the user cut off the connection between the Modbus/RTU layer and the Modbus/TCP layer is determined; if the user does not cut off the connection, the procedure proceeds to step 403, otherwise, the procedure proceeds to step 406.

At step 406, the Modbus/RTU layer sends out a disconnect request to the data exchange layer, and the data exchange layer starts analyzing and converting the language according to the data format standard of TCP and RTU.

At step 407, the data exchange layer delivers the converted disconnect request to the Modbus/TCP layer, and the Modbus/TCP layer submits a disconnect reply to the data exchange layer, then, after the data exchange layer confirms and completes the disconnection, the data exchange layer further sends a disconnect response to the Modbus/RTU layer.

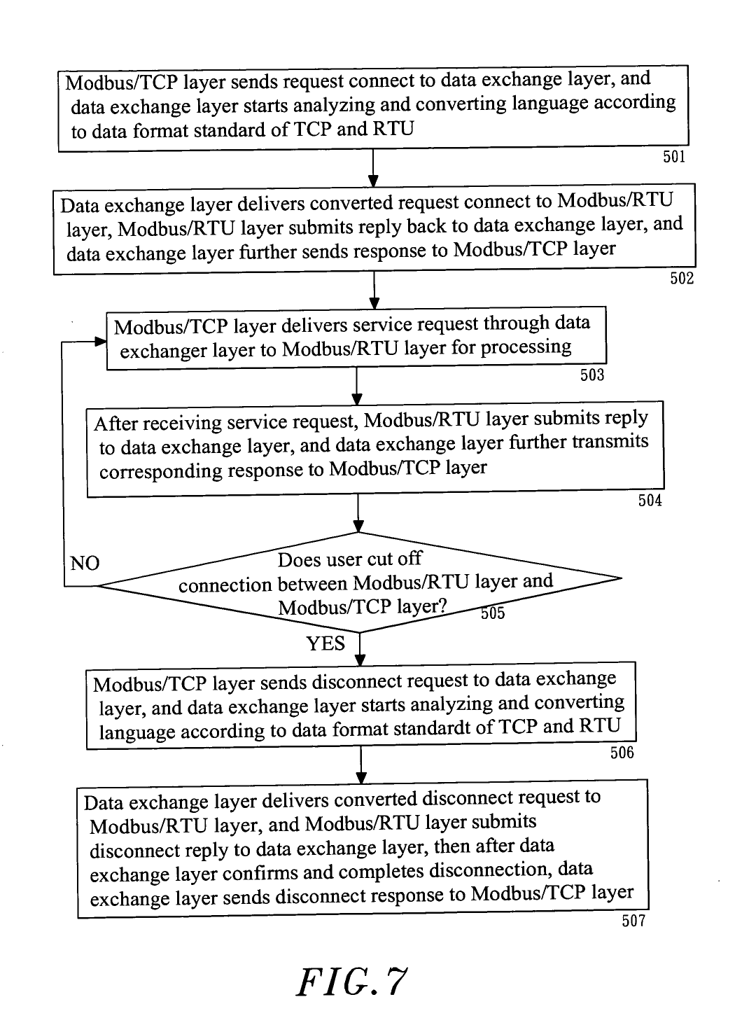

On the contrary, when the host terminal 1 is connected to the I/O controller 3, the process of sending the command or data from the I/O controller 3 to the host terminal 1 is illustrated in FIG. 7. The process of converting the Modbus/RTU format into the Modbus/TCP format is described as following.

At step 501, the Modbus/TCP layer sends a request connect to the data exchange layer, and the data exchange layer starts analyzing and converting the language according to the data format standard of TCP and RTU.

At step 502, the data exchange layer delivers the converted request connect to the Modbus/RTU layer, the Modbus/RTU layer submits a reply back to the data exchange layer, and the data exchange layer further sends a response to the Modbus/TCP layer.

At step 503, the Modbus/TCP layer delivers a service request through the data exchanger layer to the Modbus/RTU layer for processing.

At step 504, after receiving the service request, the Modbus/RTU layer submits a reply to the data exchange layer, and the data exchange layer further transmits a corresponding response to the Modbus/TCP layer.

At step 505, whether the user cuts off the connection between the Modbus/RTU layer and the Modbus/TCP layer is determined; if the user does not cut off the connection, the procedure proceeds to step 503, otherwise, procedure proceeds to step 506.

At step 506, the Modbus/TCP layer sends a disconnect request to the data exchange layer, and the data exchange layer starts analyzing and converting the language according to the data format standard of TCP and RTU.

At step 507, the data exchange layer delivers the converted disconnect request to the Modbus/RTU layer, and the Modbus/RTU layer submits a disconnect reply to the data exchange layer, then after the data exchange layer confirms and completes the disconnection, the data exchange layer sends a disconnect response to the Modbus/TCP layer.

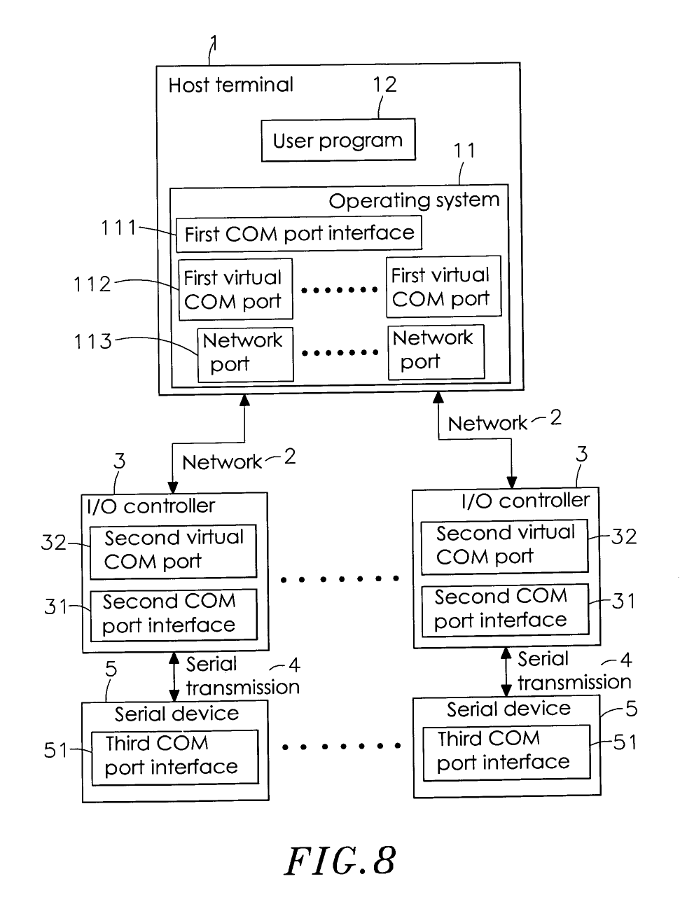

FIG. 8 is a block diagram according to another preferred embodiment of the present invention. This embodiment is substantially similar to the aforesaid first embodiment with the exception that the host terminal 1 comprises a plurality of first virtual COM ports 112 orderly connected to a plurality of I/O connectors 3 through respective network port 113 and network 2. Thus, the host terminal 1 can control a plurality of I/O controllers 3 by connecting to at least one first virtual COM port 112 at the same time.

Thus, according to an aspect of the present invention, the commands or data can be converted into a format acceptable for the first COM port interface 111 in the host terminal 1 or the second COM port interface 31, along with the network connection, the programmer or the user can use the first COM port interface 111 as the communication interface between the host terminal 1 and the I/O controller 3 in order to reduce the cost of development for the programmer and user.

Therefore, the present invention has at least the following advantages.

1. When the host terminal 1 connects to the plurality of I/O controllers 3 through the network 2 for the commands or data transmission, the first virtual COM port 112 of the host terminal 1 and the second virtual COM port 32 of the I/O controller 3 convert the commands or data into the Modbus/RTU or Modbus/TCP format. Thus, the host terminal 1 and I/O controller 3 can mutually transmit and receive the commands or data through the network 2 for controlling. Accordingly, instability caused by the new development program can be overcome and the time consumption and cost for developing the program or the system for a particular device can also be reduced.

2. The user can execute the format conversion in the first virtual COM port 112 of the host terminal 1 and the second virtual COM ports 32 of the plurality of the I/O controllers 3 to enable the host terminal 1 and the I/O controllers 3 mutually transmit the commands or data. The user just downloads the software with the functions of the first virtual COM port 112 and the second virtual COM port 32 or externally connects the firmware with the functions of the first virtual COM port 112 and the second virtual COM port 32 to the host terminal 1 and the I/O controller 3. Thus, the user need not be very experienced or have strong knowledge background. Accordingly, the maintenance can be simple and carried out easily.

3. The user can execute the format conversion in the first virtual COM port 112 of the host terminal 1 and the second virtual COM ports 32 of the plurality of the I/O controllers 3, and the first virtual COM port 112 and the second virtual COM port 32 can be a software or a firmware compatible with any operating system 11 and the Modbus/RTU format in the user program 12. Therefore, the user only has to download the software into the original host terminal 1 and the plurality of I/O controllers 3, or to externally connect the firmware to the host terminal 1 and the plurality of I/O controllers 3. Thus, the user need not build up a new system, or convert the format between the Modbus/RTU format and the Modbus/TCP format through another system. In other words, the user need not learn another new system.

4. The first COM port interface 111 is an essential interface in the operating system 11, and the host terminal 1 and the peripheral components connected to the host terminal 1 mostly use the first COM port interface 111. Therefore, the first COM port interface 111 is the familiar interface to most programmers and users in the field, for example, serial port interface of RS-232, 485 and 422. Therefore, by means of the command or data conversion function provided by the first virtual COM port 112, the programmer or user can use the familiar first COM port interface 111 as the communication interface between the host terminal 1 and the I/O controller 3 to prevent error from occurring due to not being aware the feature of the second COM port interface 31. Accordingly, instability caused by the new development program can be overcome and the time consumption and cost for developing the program or the system for a particular device can be reduced.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What the invention claimed is:

1. A virtual COM port for Modbus gateway Ethernet I/O, comprising:
a host terminal, comprising an operating system which having a first virtual COM port for converting commands or data between the Modbus/RTU format and the Modbus/TCP format, a first COM port interface for receiving and processing the converted commands or data, and a network port connected an external network, and a user program developed based on a command format compatible with said first COM port interface, comprises a pre-set library and a instruction set format based on a transmission command format of said first COM port interface of said operating systems; and
an I/O controller connected to said host terminal through said external network, comprising a second COM port interface and a second virtual COM port for converting the commands or data between the Modbus/RTU format and the Modbus/TCP format.

2. The virtual COM port for Modbus gateway Ethernet I/O according to claim 1, wherein said operating system comprises Windows or Linux.

3. The virtual COM port for Modbus gateway Ethernet I/O according to claim 1, wherein said second COM port is connect to a third COM port in a serial device through a serial transmission.

4. The virtual COM port for Modbus gateway Ethernet I/O according to claim 1, wherein said external network comprises an Ethernet or a wireless LAN.

5. The virtual COM port for Modbus gateway Ethernet I/O according to claim 1, wherein said host terminal comprises a personal computer or an industrial computer.

6. The virtual COM port for Modbus gateway Ethernet I/O according to claim 1, wherein said I/O controller comprises an electronic switch, a digital or an analogue switch.

7. A method for virtual COM port for Modbus gateway Ethernet I/O comprising a host terminal, an I/O controller, and a serial device connected to said host terminal through said I/O controller, wherein a conversion process for said host terminal to transmit commands or data to said serial device including the steps of:
(A) starting said conversion process;
(B) transmitting the commands or data from said host terminal to a user program;
(C) transmitting the commands or data from said user program to a first virtual COM port and commanding said first virtual COM port to convert the commands or data from the Modbus/RTU format into the Modbus/TCP format;
(D) transmitting the converted commands or data from said first virtual COM port to a second virtual COM port of said I/O controller through a network port of said host terminal and a network;
(E) converting the commands or data from the Modbus/TCP format into the Modbus/RTU format by using said second virtual COM port, and transmitting the converted commands or data to a second COM port interface of said I/O controller;
(F) transmitting the commands or data from said second COM port interface of said I/O controller to said serial device through a serial transmission and a third COM port interface in said serial device for executing; and
(G) ending said conversion process.

8. The method for virtual COM port for Modbus gateway Ethernet I/O according to claim 7, wherein said user program in the step (B) is developed based on a command format of said first COM port interfaces and comprises the steps of:
(B1) providing an application program interface of a pre-set library and an instruction set format by using an operating system based on a transmission command format of said first COM port interface of said various operating systems;
(B2) providing a high-level SDK and a library by using said operating system for backing up said application program interface; and
(B3) transmitting a command or data by using said application program interface, said high-level SDK or said library in the Modbus/RUT format to said user program to complete the program development.

9. The method for virtual COM port for Modbus gateway Ethernet I/O according to claim 7, wherein the conversion in said first virtual COM port interface from the Modbus/RTU format into the Modbus/TCP format in the step (C) comprises the steps of:
(C1) sending a request connect from a Modbus/RTU layer to a data exchange layer, wherein said data exchange layer starts to analyze and convert a language according to a data format standard of TCP and RTU;
(C2) sending the converted request connect from said data exchange layer to a Modbus/TCP layer, wherein said Modbus/TCP layer further submits a reply back to said data exchange layer, and then said data exchange layer sends a response to said Modbus/RTU layer;
(C3) selecting an I/O operation compatible and supported with said second COM port interface of said I/O controller from said user program by using said Modbus/RTU layer and transmitting to said data exchange layer, and further delivering a service request from said data exchange layer to said Modbus/TCP layer for processing;
(C4) submitting a reply to said data exchange layer from said Modbus/TCP layer after receiving said service request, wherein said data exchange layer further transmits a corresponding response to said Modbus/RTU layer;
(C5) determining whether a user cuts off a connection between said Modbus/RTU layer and said Modbus/TCP layer, wherein if it is determined that the user does not cut off the connection, the process returns to step (C3), otherwise, the process proceeds to step (C6);
(C6) sending a disconnect request to said data exchange layer from said Modbus/RTU layer, wherein said data exchange layer starts to analyze and convert a language according to a data format standard of TCP and RTU; and
(C7) delivering the converted disconnect request to said Modbus/TCP layer from said data exchange layer, wherein said Modbus/TCP layer submits a disconnect reply to said data exchange layer after receiving the disconnect request, and after said data exchange layer confirms and completes the disconnection, said data exchange layer further sends a disconnect response to said Modbus/RTU layer.

10. The method for virtual COM port for Modbus gateway Ethernet I/O according to claim 7, wherein the conversion in said second virtual COM port from the Modbus/TCP format into the Modbus/RTU format in the step (E) comprises the steps:
(E1) sending a request connect from a Modbus/TCP layer to a data exchange layer, wherein said data exchange layer starts to analyze and convert a language according to a data format standard of TCP and RTU;
(E2) sending the converted request connect from said data exchanged layer to a Modbus/RTU layer, wherein said Modbus/RTU layer further submits a reply back to said data exchange layer, and then said data exchange layer sends a response to said Modbus/TCP layer;
(E3) transmitting a service request from said Modbus/RTU layer to said Modbus/TCP layer through said data exchange layer for processing;
(E4) submitting a reply to said data exchange layer from said Modbus/RTU layer after receiving said service request, wherein said data exchange layer further transmits a corresponding response to said Modbus/TCP layer;
(E5) determining whether a user cuts off the connection between said Modbus/RTU layer and said Modbus/TCP layer; wherein if it is determined that the user does not cuts off the connection, the process returns to step (E3), otherwise, the process proceeds to step (E6);
(E6) sending a disconnect request to said data exchange layer from said Modbus/TCP layer, wherein said data exchange layer starts to analyze and convert a language according to a data format standard of TCP and RTU; and
(E7) delivering the converted disconnect request to said Modbus/RTU layer from said data exchange layer, wherein said Modbus/RTU layer submits a disconnect reply to said data exchange layer after receiving the disconnect request, and after said data exchange layer confirms and completes the disconnection, said data exchange layer further sends a disconnect response to said Modbus/TCP layer.

11. A method for virtual COM port for Modbus gateway Ethernet I/O comprising a host terminal, an I/O controller, and a serial device connected to said host terminal through said I/O controller, wherein a conversion process for said serial device to transmit commands or data to said terminal host including the steps of:
(a) starting said conversion process;
(b) transmitting the commands or data from said serial device to a second COM port interface of said I/O controller through a third COM port interface in said serial device and a serial transmission for executing;
(c) transmitting the commands or data from said second COM port interface to a second virtual COM port in said I/O controller;
(d) converting the commands or data from the Modbus/RUT format into the Modbus/TCP format by using said second virtual COM port, and then transmitting the converted commands or data through a network to a network port in said host terminal;
(e) transmitting the commands or data from said network port to a first virtual COM port of said host terminal;
(f) converting the commands or data from the Modbus/TCP format into the Modbus/RTU format by using said first virtual COM port, wherein said first virtual COM port further transmits the converted commands and data to a first COM port interface of said host terminal for processing; and
(g) ending said conversion process

12. The method for virtual COM port for Modbus gateway Ethernet I/O according to claim 11, wherein said user program in the step (b) is developed based on a command format of said first COM port interfaces and comprises the steps of:
(b1) providing an application program interface of a pre-set library and an instruction set format by using an operating system based on a transmission command format of said first COM port interface of said various operating systems;
(b2) providing a high-level SDK and a library by using said operating system for backing up said application program interface; and
(b3) transmitting a command or data by using said application program interface, said high-level SDK or said library in the Modbus/RUT format to said user program to complete the program development

13. The method for virtual COM port for Modbus gateway Ethernet I/O according to claim 11, wherein the conversion in said second virtual COM port from the Modbus/RTU format into the Modbus/TCP format in the step (c) comprises the steps:
(c1) sending a request connect from a Modbus/RTU layer to a date exchange layer, wherein said date exchange layer starts to analyze and convert a language according to a data format standard of TCP and RTU;
(c2) sending the converted request connect command from said date exchange layer to a Modbus/TCP layer, wherein said Modbus/TCP layer further submits a reply back to said date exchange layer, and then said date exchange layer sends a response to said Modbus/RTU layer;
(c3) selecting an IO operation compatible and supported with said second COM port interface of said I/O controller from said user program by using said Modbus/RTU layer and transmitting to said date exchange layer, and further delivering a service request from said date exchange layer to said Modbus/TCP layer for processing;
(c4) submitting a reply to said date exchange layer from said Modbus/TCP layer after receiving the service request, wherein said date exchange layer further transmits a corresponding response to said Modbus/RTU layer;
(c5) determining whether a user cuts off the connection between said Modbus/RTU layer and said Modbus/TCP layer; wherein if it is determined that the user does not cut off the connection, the process returns to step (c3), otherwise, the process proceeds to step (c6);
(c6) sending a disconnect request to said date exchange layer from said Modbus/RTU layer, wherein said date exchange layer starts to analyze and convert a language according to a data format standard of TCP and RTU; and
(c7) delivering the converted disconnect request to said Modbus/TCP layer from said date exchange layer, wherein said Modbus/TCP layer submits a disconnect reply to said date exchange layer after receiving the disconnect request, and after said date exchange layer confirms and completes the disconnection, said date exchange layer further sends a disconnect response to said Modbus/RTU layer.

14. The method for virtual COM port for Modbus gateway Ethernet I/O according to claim 11, wherein the conversion in said first virtual COM port from the Modbus/TCP format into the Modbus/RTU format in the step (e) comprises the steps:
(e1) sending a request connect from a Modbus/RTU layer to a data date exchange layer, wherein said date exchange layer starts to analyze and convert a language according to a data format standard of TCP and RTU;
(e2) sending the converted request connect from said date exchange layer to a Modbus/RTU layer, wherein said Modbus/RTU layer further submits a reply back to said date exchange layer, and then said date exchange layer sends a response to said Modbus/TCP layer;
(e3) transmitting a service request from said Modbus/RTU layer to said Modbus/TCP layer through said date exchange layer for processing;
(e4) submitting a reply to said date exchange layer from said Modbus/RTU layer after receiving the service request, wherein said date exchange layer further transmits a corresponding response to said Modbus/TCP layer;
(e5) determining whether a user cuts off the connection between said Modbus/RTU layer and said Modbus/TCP layer, wherein if it is determined that the user does not cuts off the connection, the process returns to step (e3), otherwise, the process proceeds to step (e6);
(e6) sending a disconnect request to said date exchange layer from said Modbus/TCP layer, wherein said date exchange layer starts to analyze and convert a language according to a data format standard of TCP and RTU; and
(e7) delivering the converted disconnect request to said Modbus/RTU layer from said date exchange layer, wherein said Modbus/RTU layer transmits a disconnect reply to said date exchange layer after receiving the disconnect request, and after said date exchange layer confirms and completes the disconnection, said date exchange layer further sends a disconnect response to said Modbus/TCP layer.
